(19) United States
(12) Patent Application Publication
(10) Pub. No.: US 2017/0326016 A1
(43) Pub. Date: Nov. 16, 2017

(54) URN VAULT

(71) Applicant: Wilbert Funeral Services, Inc., Broadview, IL (US)

(72) Inventor: Keary Bailey, Buda, TX (US)

(73) Assignee: Wilbert Funeral Services, Inc.

(21) Appl. No.: 15/611,035

(22) Filed: Jun. 1, 2017

Related U.S. Application Data
(63) Continuation of application No. 15/591,198, filed on May 10, 2017.
(60) Provisional application No. 62/337,157, filed on May 16, 2016.

(51) Int. Cl. A61G 17/007; E04H 13/00; A61G 17/08

(52) U.S. Cl. CPC A61G 17/0136; A61G 17/08; E04H 13/008

(57) ABSTRACT

The disclosed urn vault comprises a polymeric box having one or more side walls and either a top or base. In some embodiments, the polymeric box is open at the bottom and lowers onto the base. In some embodiments, the polymeric box is open at the top, and a lid lowers onto the polymeric box's top opening. In some embodiments, the top surface of the base comprises guide rails or channels, located equidistant from the outside base edge on all sides of the base. These guide rails or channels are the fastening guide for the polymeric box, which lowers onto the base. In some embodiments, the lid comprises a top lid panel coupled to a smaller bottom lid panel. The lid lowers onto the polymeric box, and the top lid panel and bottom lid panel engage with the side walls of the polymeric box.

### REFERENCE TO RELATED APPLICATION

This application is a continuation of U.S. application Ser. No. 15/591,198, filed May 10, 2017, which claims the benefit of U.S. Provisional Application Ser. No. 62/337,157, filed May 16, 2016, both of which are incorporated by reference herein in their entirety and relied upon.

### FIELD OF THE INVENTION

The present invention relates to the field of cremation urn burial vaults for protecting burial urns containing cremated remains.

### BACKGROUND OF THE INVENTION

Presently, cremation ashes are placed into various types of cremation urns, including wood, bronze, marble, ceramic, and even plastic containers. A large percentage of these families are choosing to bury the cremation remains in cemeteries, private sites, and garden settings. If the cemetery or cremation garden requires an outer burial container for cremation ashes, or if the consumer wants additional protection for the buried urn, cremation urn burial vaults (“vaults”) are utilized to hold burial urns containing cremated remains, such as cremated human remains. Vaults currently available to consumers and made of concrete, steel, granite, marble, ceramic, stained glass, steel, or wood are unnecessarily heavy.

Many cremation urn vaults are designed with a base adhered to sidewalls and a lid that closes from the top. Essentially, many cremation urn vaults are simply heavy boxes. These existing vaults are generally intended to seal and protect the urn contained therein from contaminants and the soil environment, but can fail for various reasons. Factors contributing to the failure of vaults of existing design include problems associated with the detrimental heavy weight of existing vaults, inferior construction materials, utilization of construction materials having improper material properties for the application and design dimensions, failure to incorporate adequate dimensional tolerances in the design considering the materials of construction, selection of materials that are subject to failure or breaking down when permanently exposed to soil conditions, and problems caused by the difficulty of handling and burying heavy vaults formed of such materials.

Many vaults of existing design are very heavy and require either heavy machinery and/or extensive man-power for handling. This weight problem creates additional labor and increased costs. Concrete urn vaults, the most prominent on the market today, can weigh well over 100 lb., and those skilled in the art recognize that these are extremely difficult to lower into burial spaces. Also, most concrete vaults are installed with an additional inner polymer liner to protect the urn because over time, water and moisture will weaken the integrity of the aggregate concrete, leading to cracks and eventual failure. Once failure occurs, the plastic liners collapse, leaving the cremation urn and its contents vulnerable to underground elements. For the size required, granite and marble urn vaults are usually cost prohibitive, and their weight is similar, if not greater, than concrete. Ceramic and glass are too fragile to entrust with protecting a family's “buried” urn. Wood is a bio-degradable substance that deteriorates quickly when buried, much like water-based, aggregate concrete. Also, if a family were to request a disinterment to remove a buried urn or add an additional urn, concrete urn vaults would be extremely difficult to remove; if in fact the vault is still intact at the time of removal, the concrete lid would have to be broken in order to remove the urn. The concrete lid pieces falling into the vault could also damage the urn. Steel urn vaults do not seal, leaving the enclosed urn vulnerable to insects, molds, and more, and even galvanized steel will succumb to rust in a moist environment.

### SUMMARY OF THE INVENTION

In some aspects, disclosed herein are urn vaults for containing a cremation urn that comprise at least one side panel, each of the side panel(s) comprises an interior surface and an exterior surface, and the side panel(s) forms an enclosure for receiving the cremation urn; a top enclosure panel coupled to the at least one side panel; a base panel comprising a top side and a bottom side, wherein the side panel(s), top enclosure panel, and base panel are at least partially transparent; and at least one guide rail coupled to the top side of the base panel; wherein the exterior surface of the side panel(s) is configured for sealing mating engagement with the guide rail(s).

In some aspects, disclosed herein are urn vaults for containing a cremation urn that comprise at least one side panel, wherein each of the side panel(s) comprises an interior surface, an exterior surface, and a bottom edge, and the side panel(s) forms an enclosure for receiving the cremation urn; a top enclosure panel coupled to the side panel(s); a base panel comprising a top side and a bottom side, wherein the side panel(s), top enclosure panel, and base panel are at least partially transparent; and at least one channel formed in the top side of the base panel; wherein the bottom edge of the side panel(s) is configured for sealing mating engagement with the channel(s).

In some aspects, disclosed herein are urn vaults for containing a cremation urn that comprise at least one side panel, each of the side panel(s) comprises an interior surface, an exterior surface, and a top edge, and the side panel(s) forms an enclosure for receiving the cremation urn; a base enclosure panel coupled to the side panel(s); a lid, wherein the side panel(s), base enclosure panel, and lid are at least partially transparent; and wherein the top edge of the side panel(s) is configured for sealing mating engagement with the lid.

In some embodiments, the lid comprises a top lid panel coupled to a bottom lid panel; the top lid panel comprises a lower surface and the bottom lid panel comprises perimeter edges; and the top edge of the side panel(s) is configured for sealing mating engagement with the lower surface of the top lid panel and the interior surface of the side panel(s) is configured for sealing mating engagement with the perimeter edges of the bottom lid panel.

In some embodiments, the side panel is coupled to itself. In some embodiments, a plurality of side panels are coupled to each other. In some embodiments, a bottom edge of the side panel(s) is solvently welded to the top side of the base panel. In some embodiments, the top edge of the side panel(s) is solvently welded to the lid. In some embodiments, the top edge of the side panel(s) is solvently welded to the lower surface of the top lid panel and the interior surface of the side panel(s) is solvently welded to the perimeter edges of the bottom lid panel.

In some embodiments, at least one of the side panel(s), the top enclosure panel, the base panel, guide rail(s), or lid consist of a transparent or translucent polymer. In some embodiments, the transparent or translucent polymer is colored.

In some embodiments, the side panel(s) comprises at least one handle for transporting the urn vault. In some embodiments, the urn vault comprises at least one pedestal foot coupled to the bottom side of the base panel.

### BRIEF DESCRIPTION OF THE DRAWINGS

The novel features believed characteristic of the disclosed subject matter will be set forth in any claims that are filed later. The disclosed subject matter itself, however, as well as a preferred mode of use, further objectives, and advantages thereof, will best be understood by reference to the following detailed description of an illustrative embodiment when read in conjunction with the accompanying drawings, wherein:

FIG. 1 is a bottom perspective view of an urn vault base with the sealing guide rails attached, according to embodiments.

FIG. 2 is a top section view of an urn vault and its five-sided rectangular vault top, according to embodiments.

FIG. 3 is a top perspective view of an urn vault base with the sealing guide rails attached, according to embodiments.

FIG. 4 is a left perspective view of an urn vault top section in its sealed position on the base, according to embodiments.

FIG. 5 is a front perspective view of an urn vault top section in its sealed position on the base, according to embodiments.

FIG. 6 is a right sectional view of an urn vault top section in its sealed position on the base, according to embodiments.

FIG. 7 is a front exploded view of an urn vault with the top section separated from the base, according to embodiments.

FIG. 8 is a top perspective view of an urn vault base with channels, according to embodiments.

FIG. 9 is a cross-section view of an urn vault top section in its sealed position on a base having channels, according to embodiments.

FIG. 10 is a cross-section view of an urn vault top section in its sealed position on a base having guide rails disposed to contact the interior surfaces of the urn vault top section, according to embodiments.

FIG. 11 is a cross-section view of an urn vault top section in its sealed position on a base having guide rails disposed to contact the exterior surfaces of the urn vault top section, according to embodiments.

FIG. 12 is a right sectional view of an urn vault and its lid, according to embodiments.

FIG. 13 depicts an embodiment of an urn vault system of the current disclosure.

For purposes of clarity and brevity, like elements and components will bear the same designations and numbering throughout the Figures.

### DETAILED DESCRIPTION OF ILLUSTRATIVE EMBODIMENTS

According to subject matter disclosed herein, a cremation urn vault is of lower weight than vaults of comparable size and capacity. Having lower weight relative to their size and capacity, vaults according to the disclosed subject matter can be handled, transported, and installed in a manner requiring less complexity, fewer personnel, less and lighter capacity handling equipment, and at less expense than required for existing, heavier vaults of comparable size and capacity.

The disclosed subject matter provides lighter, more easily-handled cremation urn vaults. Disclosed subject matter provides vaults that are impervious to nature's elements to a greater degree than the above-mentioned urn vaults of existing design. The disclosed subject matter provides vaults having stronger structure than existing vaults and capable of withstanding the heavy weight of covering soil and heavy equipment that can pass across the covering soil. Disclosed subject matter provides a protective and sealable urn vault with far greater stability and durability than existing designs. The disclosed subject matter also provides vaults suitable for efficient, streamlined installation into a burial position in the ground. Embodiments also provide such vaults suitable for family members to safely lower the vault into a burial position by themselves, allowing additional opportunity for closure for grieving family and mourners. Disclosed subject matter also provides a vault that can be buried with reduced complexity and reduced installation costs. Disclosed subject matter provides a vault having a structural design and qualities of permanent durability that are suitable for selection for permanent burial of cremated remains by surviving family with confidence and peace of mind.

Disclosed subject matter also provides vaults of size, capacity, and reduced weight suitable for purchase by consumers in advance of death (“pre-need”) from suppliers such as funeral homes and funeral directors, and which can be easily handled, readily taken into immediate possession by consumers, and stored by consumers for later use at the time of death of a family member. Disclosed subject matter also provides such vaults that are suitable for customization of features desired by consumers and such as, for example, appearance features, in advance of death. Disclosed subject matter also provides such vaults that are suitable for easy handling, display, sale, and delivery by suppliers such as funeral homes and funeral directors to consumers. Disclosed subject matter provides vaults that can be readily handled, displayed, sold, and delivered in advance of death, on a pre-need basis, by suppliers such as funeral homes and funeral directors without requiring special handling equipment and heavy delivery trucks for transporting the vault to a location specified by the consumer. Disclosed subject matter provides such vaults having a design suitable for large scale, substantially automated manufacture in a relatively short manufacturing period, and with relatively low costs for manufacturing, transportation, and storage. Disclosed subject matter provides an attractive, secure, and stable sealing urn vault that does not suffer from burial position stability problems, sealing problems, structural disintegration and weakening or breakage, or installation problems suffered with existing vaults.

The disclosed subject matter provides a polymeric urn vault of sound structural design and capable of being handled easily for burial. Disclosed subject matter provides a vault that is decorative and can serve as a display for an urn in a home setting (not buried). Disclosed subject matter provides a vault that seals tightly when underground, eliminating the threat of water, air, insects, and molds entering the urn having cremated remains contained therein. Disclosed subject matter provides a vault that in a buried position is capable of withstanding the weight of soil and heavy equipment atop the soil. Disclosed subject matter provides a vault that is sealed in a proven manner. In embodiments, a vault is sealed in the manner of an inverted empty glass, which is sealed when turned upside down in a sink full of water such that trapped air inside the glass presses against and prevents entry of the surrounding water. In other embodiments, the vault is sealed with a lid covering the top opening of the vault.

The disclosed subject matter provides an extremely strong, durable, and easily handled urn vault capable of being reopened and resealed if requested, and which can be easily manufactured and quickly assembled with relative ease and reduced cost for handling and transport. In accordance with the present disclosure, there is provided a sealable polymeric urn vault that is both functional and decorative. Embodiments provide a cremation urn vault that comprises four polymeric side walls, which are coupled together to provide a completely sealed square or rectangular environment devoid of any penetration by water, moisture, air, mold, or insects. In embodiments, the urn vault includes a generally square sheet of polymer serving as the base and a generally square polymeric top panel serving as the vault top. In embodiments, four adjacent side walls are coupled to the edges of the vault top, with all four side walls protruding downward. Each opposing side wall is coupled length-wise to each adjoining side, creating a seamless polymeric box that is open at the bottom and lowers onto the base. In other embodiments, the urn vault includes a generally square sheet of polymer serving as the lid and a generally square polymeric bottom panel. In embodiments, four adjacent side walls are coupled to the edges of the bottom panel, with all four side walls protruding upward. In some embodiments, the lid comprises a generally square sheet of polymer serving as the top lid panel, which is attached to a smaller generally square sheet of polymer serving as the bottom lid panel. In some embodiments, polymeric pieces are bonded using a special solvent adhesive that molds adjoining pieces into a single entity by first softening the polymeric surfaces to be joined and subsequently fusing them together when the solvent dissipates. This leaves a strong, glue-free joint. This is referred to as “solvent welding” or “adhesive bonding.” Both terms will be used throughout this disclosure. Because the solvent adhesive used is formulated for adhering polymeric sheets together, the resulting pieces have the tensile strength of a single, solid sheet of polymer. In some embodiments, a seamless polymeric box that is open at the top or bottom is cast as a unitary piece. In embodiments, coupled to the base or lid are guide rails that are located equidistant from the outside edge of all four sides of the base or lid. This “square railing system” serves as the resting guide for the seamless polymeric box. In embodiments, the polymeric box couples to the base or lid with the four side walls resting against the inside of the four rails. The fit is such that the side walls are held securely in place by the guide rails with no opportunity to slide or move in its position on the base or lid. In other embodiments, the polymeric box couples to the base or lid with the four side walls resting against the outside of the four rails. In some embodiments, the polymeric box couples to the lid with the top portion of four side walls contacting the bottom portion of the top lid panel, and the interior portion of the four side walls contacting the edges of the bottom lid panel. The bottom lid panel serves as a guide for aligning the lid and prevents lateral movement of the lid once it is positioned on top of the polymeric box. In some embodiments, channels or recesses in the base are located equidistant from the outside of the base. This “square channel system” serves as the resting guide for the seamless polymeric box which then lowers onto the base with the four side walls resting within the channels. In embodiments, underneath the base or bottom panel are four square cubes that are positioned near each corner of the base or bottom panel. The four cubes serve as pedestal feet that enable the urn vault to be moved by being lifted from beneath the base. Also, the underneath space created by the pedestal feet may allow the use of straps or ropes if the urn vault is to be lowered into the ground, such as from any distance that makes it difficult to lower the vault by hand. In embodiments, the urn vault can be made of panels having different wall thickness such as, for example, greater wall thickness, as desired to provide support and extra protection from unusually heavy equipment or extremely harsh environments. According to embodiments, a polymeric urn vault can be altered to meet any urn size requirement. In embodiments, the urn size can be altered by increasing the height or length, or both, of the sidewalls, and the base unit dimensions can be adjusted accordingly. It will be understood that the scope of disclosed subject matter is not limited to the particular structures, dimensions or configurations set forth herein.

According to disclosed subject matter, a polymeric urn vault serves to protect the integrity of a cremation urn enclosed therein for a substantially longer period of time than concrete urn vaults when buried in soil. According to disclosed subject matter, a polymeric urn vault is impervious to the elements that target the two inherent weaknesses of concrete: weight and susceptibility to water intrusion. Unlike concrete, disclosed subject matter comprises a vault formed of polymeric material that, in one aspect, may be selected for possessing the properties of being substantially unaffected by moisture; being resistant to degradation upon prolonged exposure to chemicals present in soil environments; being substantially resistant to impact; and possessing necessary structural strength. Vaults constructed of existing materials, such as concrete, steel, marble, granite, or bronze, require extra labor and machinery to move them into place. Disclosed subject matter provides a polymeric urn vault that is very light weight and suitable for use as a decorative presentation device in the homes of families that delay urn burial. In a home, the vault can both separate and protect the cremation urn in a decorative environment until a time is selected for burial. The vault and urn can be moved to the burial location. Before the vault is lowered into the burial position with the urn inside, a solvent adhesive is administered along the inside or outside of the guide rails or inside of the base channels to permanently bond the lid or base to the adjoining walls of the vault, and thus sealing the urn inside for all time. In another embodiment, a solvent adhesive is administered along the bottom edge of the four side walls to permanently bond to the adjoining channels located in the base. In an embodiment, at the time of interment, the base or lid and the polymeric box can also be placed in position without the solvent adhesive, leaving the vault in a position to be opened at any point in the future should the family wish to do so. Even without the use of the solvent adhesive, the weight of the topsoil and grass may hold the polymeric box in place with the base or lid, sealing the urn inside, free of the threat of water, insects, mold, and the weight of heavy equipment.

Disclosed subject matter provides a sealing urn vault that protects the cremation urn in an isolated, underground environment created by trapped air pressure which prevents any water, moisture, or underground contaminants from entering the urn vault. Disclosed subject matter provides a cremation urn vault that offers a sealed environment even if the urn vault is not permanently sealed by solvent adhesive. Once the polymeric box is placed onto the base and is held in place by the base guide rails or base channels, or alternatively, the lid is placed onto the polymeric box and held in place by the lid guide rails, the trapped air pressure inside the vault provides a sealed environment in order to repel water, chemicals, and insects as when sealed permanently.

Disclosed subject matter provides a sealing cremation vault that, when the polymeric box is not solvently welded to the base or lid, the vault may be reopened simply by removing the fill dirt and separating the vault top from the base or lid at any time in the future. This is required if a family requests a disinterment or if they wish to place a second urn inside the vault, which can then be permanently sealed once the final urn is in place. No other existing cremation urn vault serves this purpose. the urn vault of the current disclosure serves that purpose. If an urn vault is not required, but the family requests the vault just to guarantee the integrity of the urn itself, this urn vault serves that purpose. If a grieving family wishes to take part in the burial ceremony to achieve closure, they may place this lightweight cremation urn vault into the designated grave space themselves. Subject matter of the disclosure serves that purpose as well, and this is an act not allowed by current heavy urn vaults. Where families wish to delay the act of interring the cremation urn, disclosed subject matter serves the purpose of providing a protective and decorative display device for the urn before the burial.

Reference now should be made to the drawings, in which the same reference numbers are used throughout the different figures to designate the same components.

It will be understood that, although the terms first, second, third, etc. may be used herein to describe various elements, these elements should not be limited by these terms. These terms are only used to distinguish one element from another element. Thus, a first element discussed below could be termed a second element without departing from the teachings of the present disclosure.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprises” and/or “comprising” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

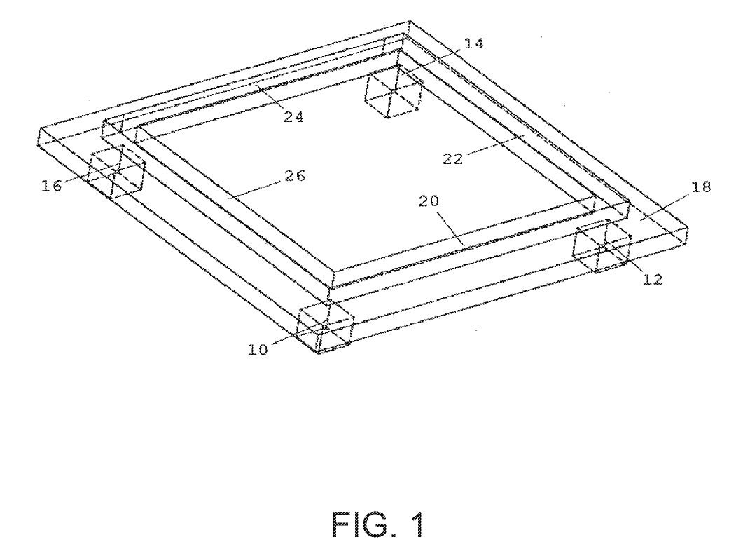

The current disclosure will now be described more fully, referencing the accompanying FIGS. 1-7 in which embodiments of the disclosure are shown. The disclosure may also be embodied in several different forms and should not be considered limited only to the embodiments set forth here. Those skilled in the art will recognize the accompanying embodiments as illustrative in nature and should not be seen as limiting in any way. The embodiments of the current disclosure will fully disclose the scope of the invention to those that are skilled in the art.

FIG. 1 illustrates a bottom perspective view of an urn vault base 18 in accordance with embodiments of the current disclosure. As shown in FIG. 1, according to disclosed subject matter, in embodiments urn vault includes a square base 18. One of ordinary skill will understand that base 18 need not be square, and can have any desired shape that is suitable for containing and having sealed therein a cremation urn. The base 18 as depicted in FIG. 1 may be made of an extruded, continuous cast, or cell cast polymeric material. In embodiments, the base 18 may be formed as an injection molded polymer. In a preferred embodiment, the thicknesses of the top portion and base may be ⅝″.

Referring to FIG. 1, the urn vault base 18 is depicted as a square and is supported underneath by four cubed, pedestal feet 10, 12, 14, and 16, inset from each corner. One of ordinary skill will understand that pedestal feet 10, 12, 14, and 16 need not be cubed, and can have any desired shape that is suitable for supporting base 18. In some embodiments, the urn vault base 18 may have three pedestal feet, and in other embodiments, the urn vault base 18 may have five or more pedestal feet. Supporting the base 18 in the front are the first pedestal foot 10 and second pedestal foot 12. Supporting the base 18 underneath at the rear are the third pedestal foot 16 and fourth pedestal foot 14. All four pedestal feet are duplicated in size and shape. The positioning of the four pedestal feet allow the polymeric urn vault base 18 to sit just above the soil when buried. In some embodiments, the pedestal feet 10, 12, 14, and 16 are attached to the underside of the base 18 using an adhesive solvent. A solvent adhesive molds adjoining pieces into a single entity by first softening the polymeric surfaces to be joined and then fusing them together when the solvent dissipates, leaving a strong glue-free joint. This is referred to as “solvent welding”. In some embodiments, the base 18 and the pedestal feet 10, 12, 14, and 16 are formed as a unitary piece through injection molding. In an alternative embodiment, the pedestal feet 10, 12, 14, and 16 may be screwed into threaded recesses found on the bottom of the base 18. The screws may be embedded within the pedestal feet 10, 12, 14, and 16, or the pedestal feet may comprise threaded portions. Also, the pedestal feet 10, 12, 14, and 16 allow the urn vault to be easily lifted, placed, and moved about on a shelf or table when it serves as a presentation device prior to interment. The space created by the pedestal feet 10, 12, 14, and 16 would allow the use of straps or ropes if the urn vault is to be lowered into the ground any distance that might make it difficult to be lowered by hand. In a preferred embodiment, the dimensions of the urn vault base 18 may be 12″×12″ and the dimensions of the cubed pedestal feet 10, 12, 14, and 16 may be 1″×1″×1″. In a further embodiment, the cubed pedestal feet 10, 12, 14, and 16 may be inset 1″ from each corner of the urn vault base 18.

FIG. 1 further illustrates the guide rail sealing system. In embodiments, the four depicted guide rails 20, 22, 24, and 26 are solvently welded to the base 18. In embodiments, the four depicted guide rails 20, 22, 24, and 26 and the base 18 are formed as a unitary piece through injection molding. The base 18 comprises first guide rail 20, second guide rail 22, third guide rail 24, and fourth guide rail 26. In other embodiments, depending upon the number of side panels in the top section, there may be greater or fewer than four guide rails. These rails provide the fastening system for the polymeric box, where the sidewalls fit snugly against the inner or outer edges of the guide rails. The sidewalls may be solvently welded to the guide rails, which seals the urn vault and prevents intrusion of air or water. In some embodiments, the four guide rails 20, 22, 24, and 26 each measure 9.75″×0.625″×0.625″. In other embodiments, the dimensions of the guide rails 20, 22, 24, and 26 may vary in length, width, and/or height from the above mentioned guide rail embodiments.

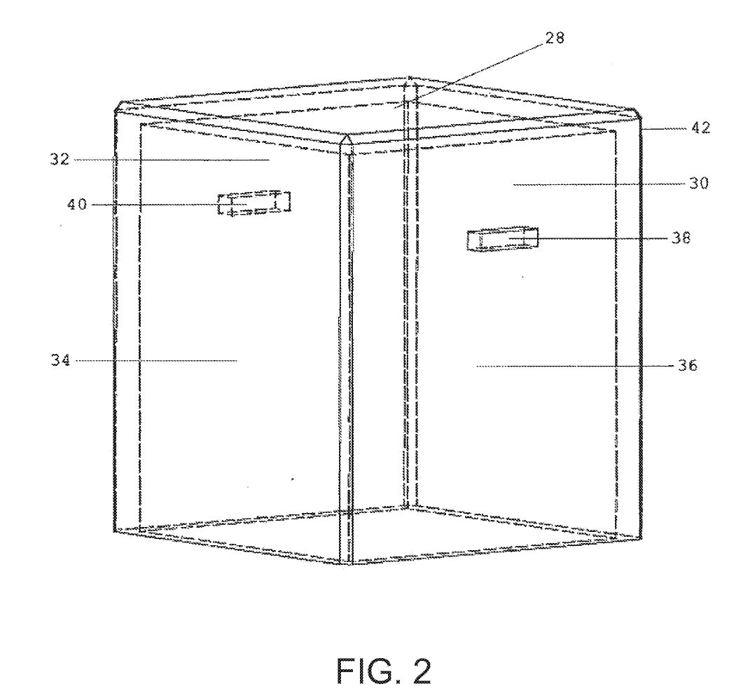

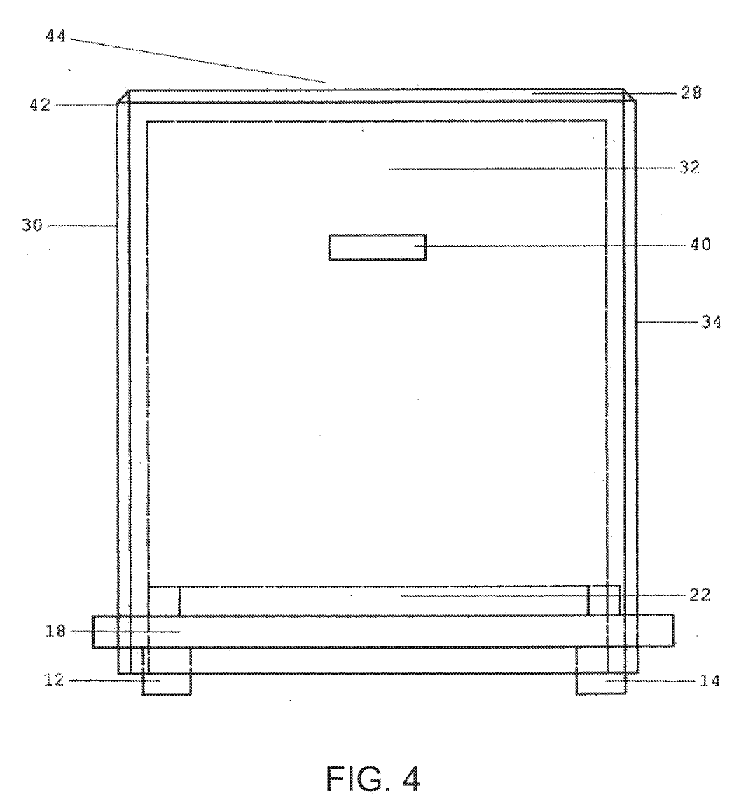

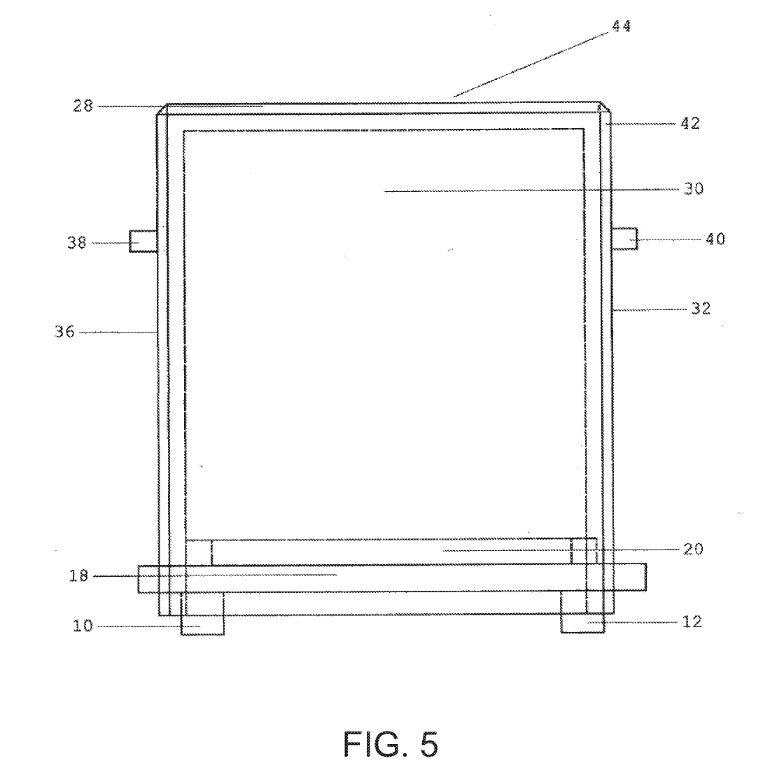

FIG. 2 illustrates a view of the polymeric box 42 in accordance with embodiments of the current disclosure. The polymeric box 42 is comprised of a generally square top panel 28, a first side wall 30, a second side wall 32, a third side wall 34, and a fourth side wall 36. In embodiments, each panel is made of extruded, continuous cast, or cell cast polymer and all are solvently welded to their adjacent panels. An adhesive solvent distributed at each connecting joint molds the five polymeric pieces into a strong, single, weight-bearing entity. In other embodiments, the top panel 28, first side wall 30, second side wall 32, third side wall 34, and fourth side wall 36 are formed a unitary piece through injection molding. All five polymeric pieces form a single entity that is open at the bottom and serves as the polymeric box 42. One of ordinary skill will understand that the top panel 28 may be a shape other than square, and there may be greater or fewer than four side panels. Also illustrated in FIG. 2 are the opposing top handles, a first handle 38 and a second handle 40. The first handle 38 and a second handle 40 are disposed on the exterior-facing sides of the first side wall 30 and third side wall 34 or the second side wall 32 and the fourth side wall 36. Each handle may be approximately centered on each opposing side wall 30 and 34 or may be placed on another area of the side wall 30 and 34 in certain embodiments. The side handles 38 and 40 enable the assembled urn vault 44 (FIGS. 4 and 5) to be lifted and lowered with ease. In embodiments, the handles 38 and 40 may be made of polymer. When the handles 38 and 40 are made of polymer, the handles 38 and 40 may be attached to the side walls 30 and 34 using a solvent adhesive. In embodiments, the handles 38 and 40 and the side walls 30 and 34 may be a unitary piece formed by injection molding. In a preferred embodiment, the handles 38 and 40 may have dimensions of 2″×5″×0.375″. In another preferred embodiment, the handles 38 and 40 may be placed 3″ below the top panel 28.

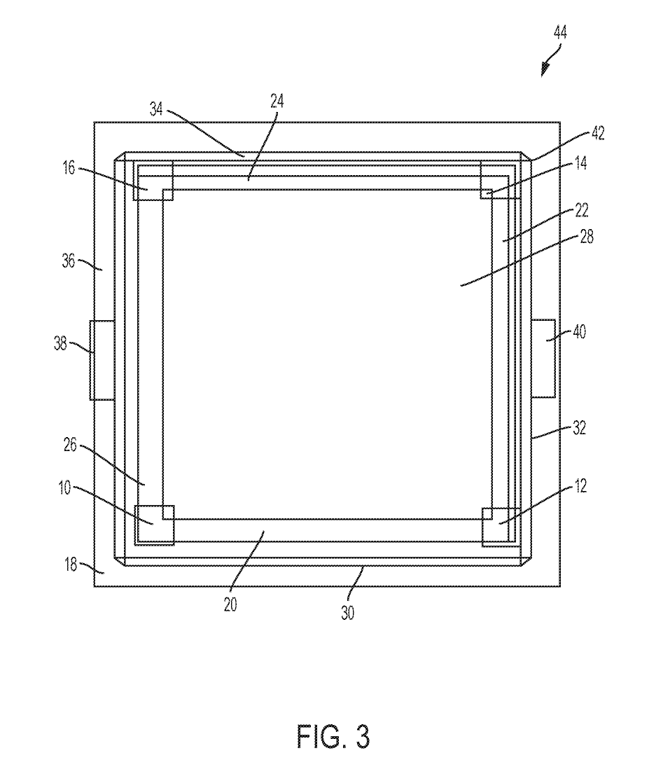

Referring now to FIG. 3, FIG. 3 displays a top perspective view of an embodiment of an urn vault 44 and includes a view of the polymeric box 42 resting in its sealing position on the base 18 and contacting the outer sides of the base guide rails 20, 22, 24, and 26. In embodiments, the polymeric box 42 resting in its sealing position on the base 18 may contact the inner sides of the base guide rails 20, 22, 24, and 26 instead. The perspective is looking downward on the polymeric box 42 and looking through the generally square top panel 28 to the base 18. Also evident are the four stabilizing pedestal feet 10, 12, 14, 16. The guide rails 20, 22, 24, and 26 are disposed on the top side of the base 18. The guide rails 20, 22, 24, and 26 may comprise interior, top, and exterior side. FIG. 3 illustrates the interior sides of the four downward-extending side walls 30, 32, 34, and 36 resting tightly against the exterior sides of the rails 20, 22, 24, and 26. In some embodiments, the exterior sides of the four downward-extending side walls 30, 32, 34, and 36 rest tightly against the interior sides of the rails 20, 22, 24, and 26. This positioning of the side walls 30, 32, 34, and 36 against the guide rails 20, 22, 24, and 26 stabilizes the polymeric box 42 on the base 18 and keeps the polymeric base from becoming displaced in any way once interred. Once the urn vault 44 is ready to be interred, the polymeric box 42 may be solvently welded to the base 18 at the guide rails 20, 22, 24, 26. This will permanently seal the vault 44 air and water tight.

FIG. 3 further illustrates the two side handles 38 and 40 as well as the first, second, third, and fourth side walls 30, 32, 34, and 36. When weight or backfill dirt is placed on the polymeric box 42 of the urn vault 44, the sealing nature of the polymeric urn vault 44 distributes the weight from the top to the base 18 and through the pedestal feet 10, 12, 14, and 16. FIG. 3 also shows that the area of the base 18 is greater than the cross-sectional area of the polymeric box 42, which allows for much easier handling of the urn vault 44. Once the polymeric box 42 has been fastened to the base 18, any weight, such as backfilling soil that is placed on top and/or around this urn vault 44 is transferred to the base 18 near the guide rails 20, 22, 24, and 26 and is then moved to the outside base edges where it is dispersed. In a preferred embodiment, the base 18 extends ½″ beyond each of the first, second, third, and fourth side walls 30, 32, 34, and 36.

Further illustrated in FIG. 4 is an embodiment of the urn vault 44 viewed from a side perspective. More specifically, the embodiment of the urn vault 44 displays a second side wall 32 coupled to a top panel 28 and coupled to adjoining first and third side walls 30 and 34. Coupled to the second side wall 32 is the second handle 40. Also evident is the base 18 and attached second and third pedestal feet 12 and 14. According to the preferred embodiment displayed in FIG. 4, the polymeric box 42 is in its sealing position with the interior face of the second side wall 32 resting firmly against the outside edge of the second guide rail 22. In embodiments, the exterior face of the second side wall 32 rests firmly against the inside edge of the second guide rail 22 instead. Application of a solvent welds the exterior of the second side wall 32 with the inside of the second guide rail 22 or the interior of the second side wall 32 with the outside of the second guide rail 22. These two entities fuse together to form one single solid piece, and the process is repeated with the fourth side wall 36 and fourth guide rail 26, as well as with the first and third side walls 30 and 34 and the first and third guide rails 20 and 24. This sealing position stabilizes the polymeric box 42 of the urn vault 44 and does not allow it to be moved or displaced in any way once it is buried. This in turn makes disengagement or a breach of the sealing system impossible.

The disclosed polymeric urn vault embodiment also surpasses the benefits of any present urn burial vaults in that the polymeric box 42 may be placed onto the base 18 without being solvently welded to the base guide rails 20, 22, 24, and 26, and trapped air inside the polymeric box 42 may prevent intrusion of air and water into the polymeric urn vault 44, providing a completely sealed environment devoid of any penetration by water, moisture, air, or insects. The additional benefit here is that the polymeric urn vault 44, after ground burial, may then be uncovered at some point in the future and reopened in order to add an additional urn. The weight of the overhead fill soil keeps the polymeric box 42 in place and guarantees the enclosed urn will remain protected and free of any underground contaminants. Once a second urn is added, the polymeric box 42 may be solvently welded to the polymeric base 18 and its accompanying guide rails 20, 22, 24, and 26. By using the polymeric urn vault, consumers may avoid additional expenses by not having to purchase duplicate urn burial vaults.

Referring now additionally to FIG. 5, FIG. 5 illustrates a front perspective of an embodiment of an urn vault 44 set forth herein. As in FIG. 4, FIG. 5 shows the urn vault 44 with the polymeric box 42 in its seated position on the base 18. The interior face of the first side wall 30 is positioned directly against the outer edge of the first guide rail 20 and is solvently welded to that outer edge. In embodiments, exterior face of the first side wall 30 is positioned directly against the inner edge of the first guide rail 20 and is solvently welded to that inner edge. The location of the second handle 40 and the first handle 38 is noted. In embodiments, the first handle 38 may be solvently welded to the fourth side panel 36 and the second handle 40 may be solvently welded to the second side panel 32. In other embodiments, the handles and side panels are formed as a unitary piece through injection molding. Best illustrated in the current embodiment are the first and second base pedestal feet 10 and 12 which aid in the handling of the urn vault 44.

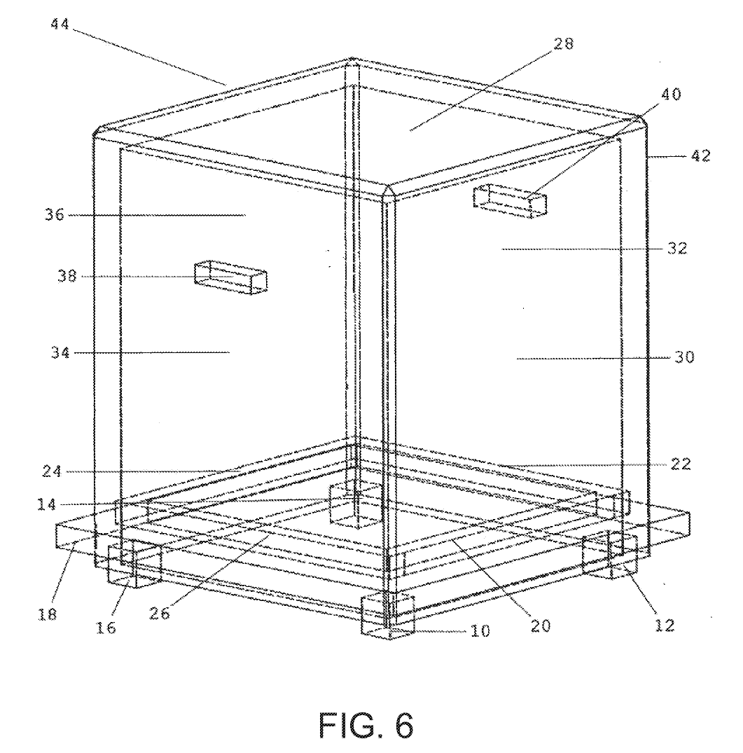

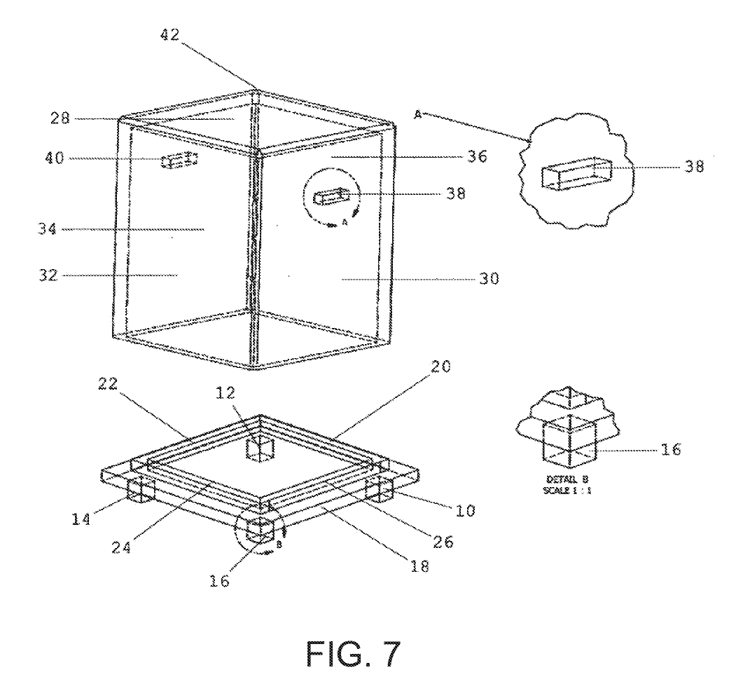

As further illustrated in FIGS. 6-7, the generally square base 18 may include four cubed pedestal feet 10, 12, 14, and 16. The feet are located just inside each corner of the base 18, enabling the base 18 to be more easily maneuvered by funeral professionals and consumers alike. Specifically, FIG. 6 details a right perspective of an embodiment of an urn vault 44, illustrating the polymeric box 42 securely positioned on the base 18. In some embodiments, the generally square top panel 28 is solvently welded to all four downward-extending side walls 30, 32, 34, and 36. With the top panel 28 and all four side walls 30, 32, 34, and 36 solvently welded to each adjoining panel, the polymeric box 42 becomes a single structural entity and further optimizes the incredible strength of the structure of the urn vault. In other embodiments, the generally square top panel 28 and the four downward-extending side walls 30, 32, 34, and 36 are formed as a unitary polymeric box 42 through injection molding. Once the polymeric box 42 is solvently welded to the base guide rails 20, 22, 24, and 26, the first handle 38 and second handle 40 allow the urn vault 44 to be easily lifted and moved into position for burial or relocated to a display position.

Referring to FIG. 7, an embodiment of the urn vault 44 details a right perspective of the polymeric box 42 prior to its fastening to the base 18. Again, the top panel 28 is coupled to the downward-extending first 30, second 32, third 34, and fourth 36 side walls through solvent welding or injection molding. The first handle 38 is coupled to the fourth side panel 36 and second handle 40 is coupled to the second side panel 32 through solvent welding or injection molding. Attention may be drawn to the presence of the base 18 and its guide rail fastening system with first guide rail 20, second guide rail 22, third guide rail 24, and fourth guide rail 26 disposed on the top surface of the base 18. Each guide rail is coupled to its adjacent guide rails and to the base 18 underneath each rail by solvent welding or injection molding. In a preferred embodiment, the guide rails 20, 22, 24, and 26 are placed 1″ from the edges of the base 18. Raising the base 18 for easier mobility are the base pedestal feet, including the first pedestal foot 10, second pedestal foot 12, third pedestal foot 14, and fourth pedestal foot 16.

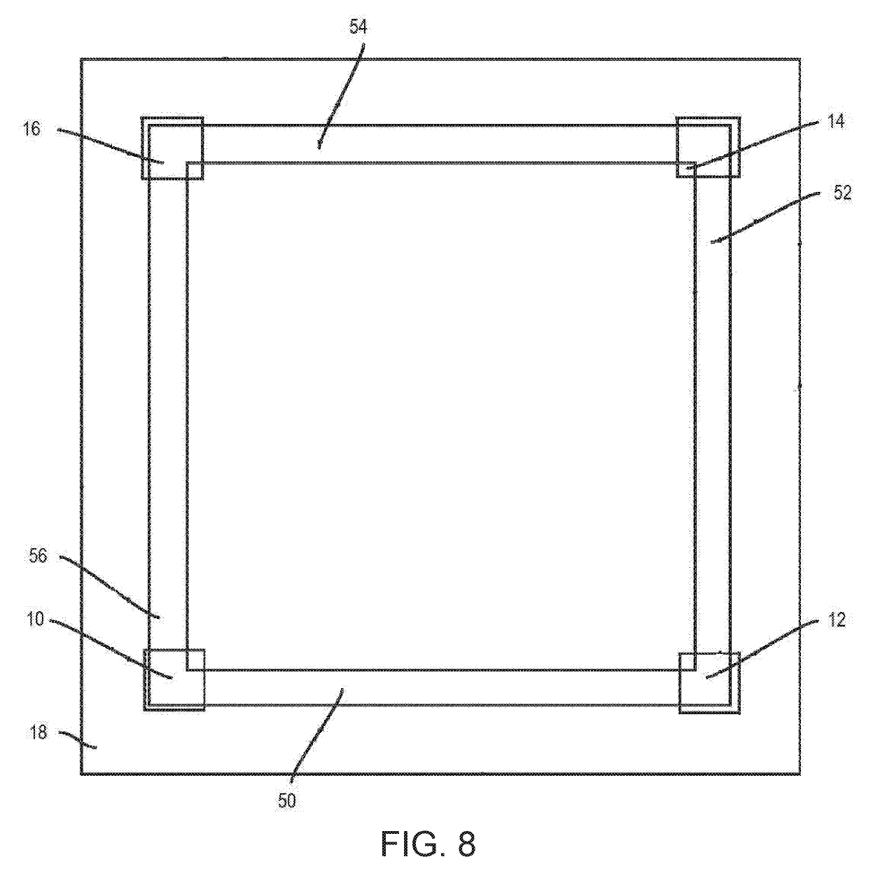

FIG. 8 illustrates the channel sealing system base 18. The urn vault base 18 is depicted as a square and is supported underneath by four cubed, pedestal feet 10, 12, 14, and 16, inset from each corner. A first channel 50, a second channel 52, a third channel 54, and a fourth channel 56 are disposed on the top surface of base 18. The four channels are inset from the side edges of the base 18. The four channels 50, 52, 54, and 56 are configured to receive the bottom edges of the polymeric box 42. These channels provide the fastening system for the polymeric box, where the sidewalls fit snugly inside the channels. The sidewalls may be solvently welded to the channels, which seals the urn vault and prevents intrusion of air or water. In embodiments, the four channels 50, 52, 54, and 56 are formed in the top surface of the base 18 through injection molding. In other embodiments, the four channels 50, 52, 54, and 56 are formed in the top surface of the base 18 through an etching process. In other embodiments, depending upon the number of side panels in the top section, there may be greater or fewer than four guide rails. In some embodiments, the four channels 50, 52, 54, and 56 each measure 11 inches long, 0.66 inches wide, and 0.375 inches deep.

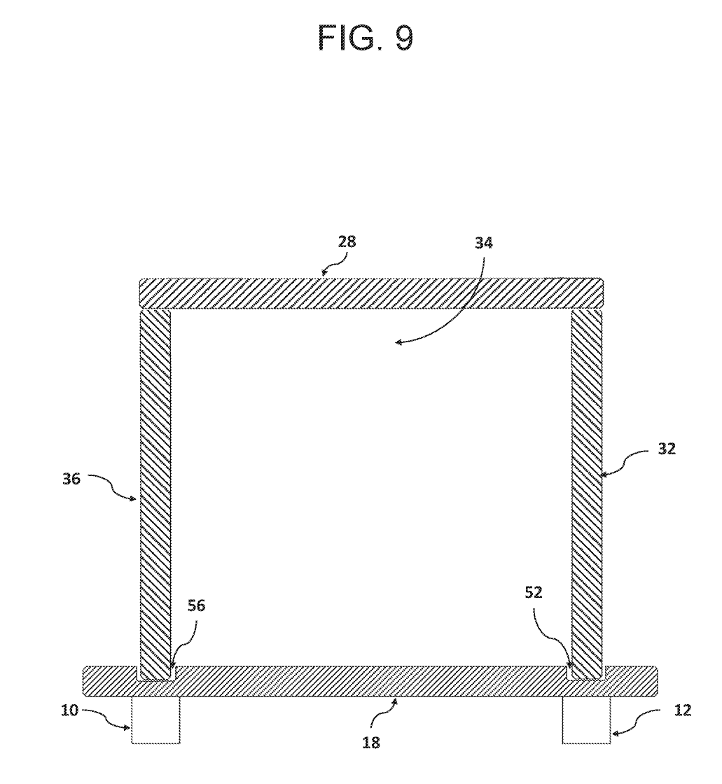

FIG. 9 depicts a cross-sectional view of the polymeric box 42 in its sealed position on a base 18 having channels. The cross section of the polymeric box 42 depicts cross sections of the second side wall 32, fourth side wall 36, top panel 28, and base 18. The cross sections of the second channel 52 and fourth channel 56 are also illustrated. As shown in the figure, when the polymeric box 42 is in its sealed position on a base 18, the bottom edge of second side wall 32 is engaged with second channel 52, and the bottom edge of fourth side wall 36 is engaged with fourth channel 56. The bottom edges of the four side walls may be solvently welded to the four channels to permanently seal the urn vault 44.

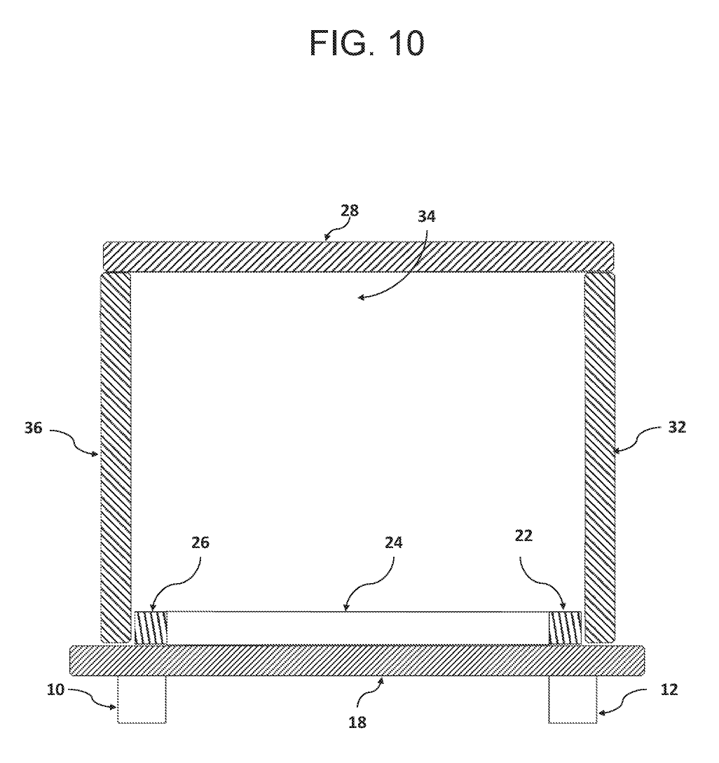

FIG. 10 depicts a cross-sectional view of the polymeric box 42 in its sealed position on one embodiment of a base 18 having guide rails. The cross section of the polymeric box 42 depicts cross sections of the second side wall 32, fourth side wall 36, top panel 28, base 18, second guide rail 22, and fourth guide rail 26. As shown in the figure, when the polymeric box 42 is in its sealed position on a base 18, the inside edge of second side wall 32 is engaged with the outside edge of second guide rail 22, and the inside edge of fourth side wall 36 is engaged with the outside edge of fourth guide rail 26. The inside edges of the four side walls may be solvently welded to the outside edges of the four guide rails to permanently seal the urn vault 44.

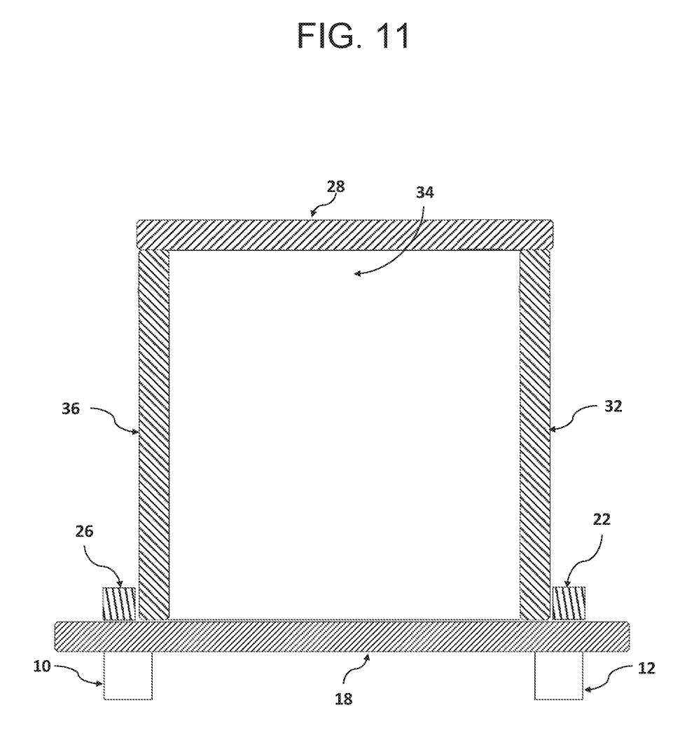

FIG. 11 depicts a cross-sectional view of the polymeric box 42 in its sealed position on another embodiment of a base 18 having guide rails. The cross section of the polymeric box 42 depicts cross sections of the second side wall 32, fourth side wall 36, top panel 28, base 18, second guide rail 22, and fourth guide rail 26. As shown in the figure, when the polymeric box 42 is in its sealed position on a base 18, the outside edge of second side wall 32 is engaged with the inside edge of second guide rail 22, and the outside edge of fourth side wall 36 is engaged with the inside edge of fourth guide rail 26. The outside edges of the four side walls may be solvently welded to the inside edges of the four guide rails to permanently seal the urn vault 44.

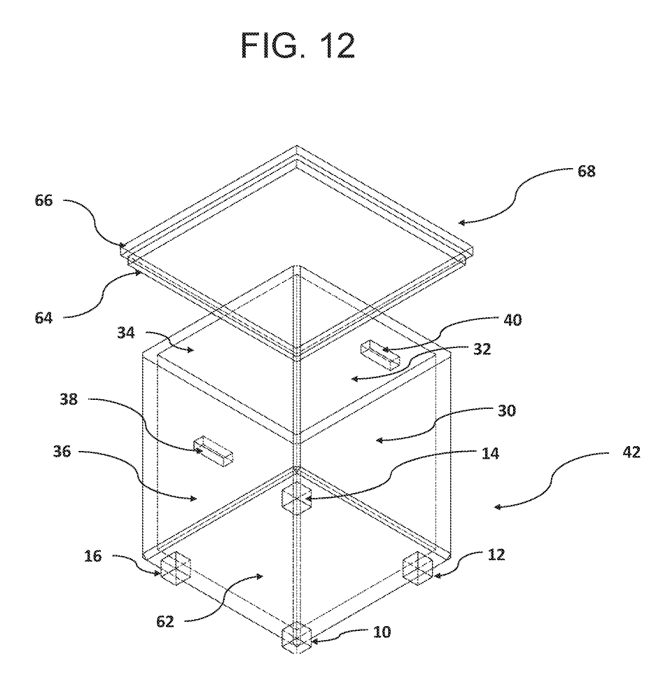

FIG. 12 is a right sectional view of an embodiment an urn vault having a detachable lid 68. Polymeric box 42 comprises bottom panel 62 coupled to the upward-extending first 30, second 32, third 34, and fourth 36 side walls through solvent welding or injection molding. Lid 68 comprises a generally square polymeric top lid panel 66 and a generally square polymeric bottom lid panel 64. The bottom lid panel 64 has a smaller surface area than the top lid panel 66. In some embodiments, the lower surface of the top lid panel 66 is coupled to the upper surface of the bottom lid panel 64 using an adhesive solvent. In other embodiments, the top lid panel 66 and the bottom lid panel 64 are formed as a unitary piece through injection molding. When the lid 68 is in its sealed position on the polymeric box 42, the lower surface of the top lid panel 66 contacts the top edge of the four side walls 30, 32, 34, and 36, and the outside edges of the bottom lid panel 64 contact the interior surfaces of the four side walls 30, 32, 34, and 36. The lid 68 may be permanently sealed to the polymeric box 42 by applying an adhesive solvent to the lower surface of the top lid panel 66, the outside edges of the bottom lid panel 64, the top edge of the four side walls 30, 32, 34, and 36, or the interior surfaces of the four side walls 30, 32, 34, and 36. In some embodiments, the top lid panel 66 comprises a 12 inch×12 inch×0.625 inch acrylic panel, and the bottom lid panel 64 comprises a 10.75 inch×10.75 inch×0.625 inch acrylic panel. In some embodiments, the first handle 38 is coupled to the fourth side panel 36 and second handle 40 is coupled to the second side panel 32 through solvent welding or injection molding. In some embodiments, the pedestal feet 10, 12, 14, and 16 are attached to the underside of the bottom panel 62 using an adhesive solvent, injection molding, or threaded recesses.

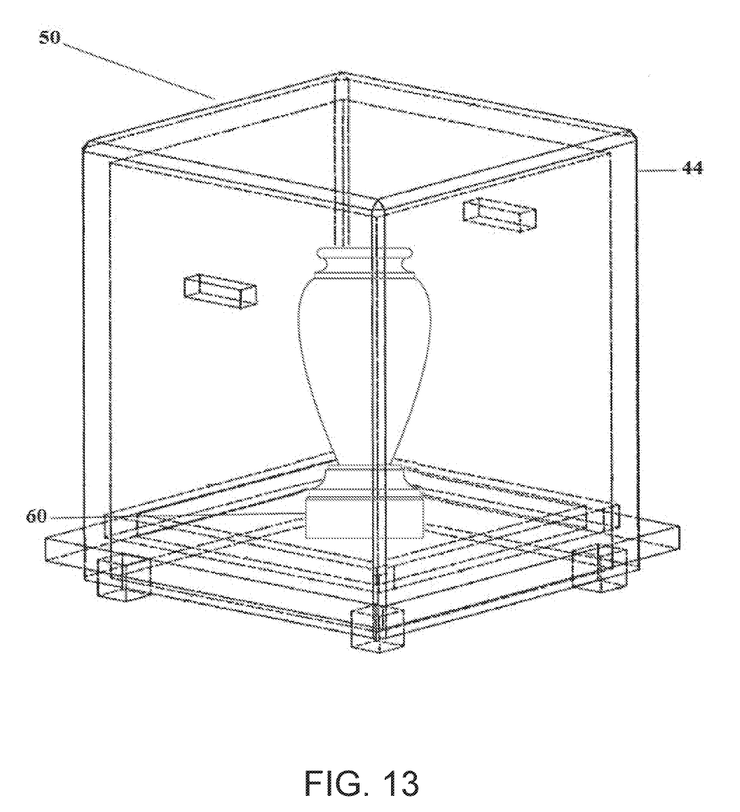

FIG. 13 depicts an embodiment of an urn vault system 50 of the current disclosure. The embodiment of the urn vault system 50 may comprise parts or features found in any of the embodiments of the urn vault 44 found in this disclosure as well as an urn 60 that may be housed within the sealed environment found within the urn vault system 50.

In a preferred embodiment, parts of the urn vault system 50 may comprise specific measurements.

In further embodiments, the above urn vault system 50 may take the shape of urn vaults 44 of aforementioned embodiments such as, but not limited to a triangle, a pentagon, and a hexagon.

In a preferred embodiment, the urn vault 44 may comprise 9.75 inch×11.5 inch×0.625 inch acrylic first and third side walls 30 and 34, 11 inch×11.5 inch×0.625 inch acrylic second and fourth side walls 32 and 36, 2 inch×0.5 inch×0.375 inch acrylic side handles 38 and 40, an 11 inch×11 inch×0.625 inch acrylic top enclosure panel 28, a 12 inch×12 inch×0.625 inch acrylic base 28, a 9 inch×0.625 inch×0.625 inch acrylic guide rails 20, 22, 24, and 26, and 1 inch×1 inch×1 inch pedestal feet 10, 12, 14, and 16.

In a preferred embodiment, all panels of the urn vault 44 may be constructed of ⅝″ thick acrylic. This urn vault, at ⅝″ thickness, has a minimum tensile strength of 1500 psi, two times more than any current concrete urn vault. One vital purpose of this acrylic urn vault is that at only 12 lb., it is very easily moved and can be handled by most any consumer, unlike the average concrete urn vault which weighs in at well over 100 lb.

In a further embodiment, preferred adhesives for solvent welding include, but are not limited to IPS Weld-On 3 and IPS Weld-On 4. These acrylic adhesives were chosen to be used on the smooth finished edges of said acrylic urn vault 44 so that the joints are clear of any residue once the adhesive dries. Other fastening systems are available for acrylic, including cyano-acrylate (super glue), methylene chloride, epoxy, and other acrylic adhesives.

The current disclosure has been described in considerable detail and those skilled in the art will recognize that modifications in the shape, size, materials, and arrangement of parts may be made. Other sizes and shapes of polymeric urn vault components may be selected to accommodate various cremation urn dimensions. For example, the urn vault may have its sides lengthened to any height for a taller urn or the base 18 may be enlarged to accommodate larger cremation box-type urns. The urn vault may be altered by adding or subtracting side panels, and the base 18 may take the shape of a triangle, pentagon, hexagon, or any suitable shape. In another embodiment, the urn vault may be altered by constructing the base 18 as a circular or oval shape. The base panel, top panel, side panels, and guide rails may also be altered accordingly to match the shape created by the side panels. For example, in order to match a circular base, a side panel may be created that is cylindrical in shape. The top panel may be circular in order to match the circular base. A single guide rail may be created that is shaped like a circle. The pedestal feet may or may not mimic the shapes of the rest of the elements of the polymeric urn vault. As a further example, if the base is pentagonal in shape, the side panels may be shaped like a pentagonal prism, the top panel may be pentagonal in shape, the guide rails may be pentagonal in shape, and the pedestal feet may or may not mimic a pentagonal shape.

Materials may vary among embodiments. In certain embodiments, the polymeric urn vault may be comprised of one or a combination of polymers such as, but not limited to polyamideimide, polyethersulphone, polyetherimide, polyarylate, polysulphone, amorphous polyamide, polymethylmethacrylate, polyvinylchloride, acrylonitrile butadiene styrene, polystyrene, polyetheretherketone, polytetrafluoroethylene, polyamide 6,6, polyamide 11, polyphenylene sulphide, polyethylene terephthalate, polyoxymethylene, polypropylene, high density polyethylene, low density polyethylene, and/or any other transparent or translucent polymer. According to an embodiment, for example, suitable polymeric material comprises polyethylene terephthalate.

Solvents may also vary among embodiments. In certain embodiments, parts of the polymeric urn vault may be solvently welded using one or more solvents such as, but not limited to acetaldehyde, acetic anhydride, acetone, hydrofluoric acid, trifluoroacetic acid, acetic acid, hydrochloric acid, nitric acid, sulfuric acid, ethyl alcohol, isobutyl alcohol, methyl alcohol, n-butyl alcohol, propyl alcohol, ammonium hydroxide, aniline, aqua regia, benzaldehyde, benzene, carbon tetrachloride, caustic soda, chlorobenzene, chloroform, cyclohexane, esters, ether, diethyl ether, isopropyl ether, methyl ether, hexane, hydrazine, hydrogen peroxide, methylene chloride, petroleum ether, phenol, sodium hydroxide, tetrahydrofuran, toluene, trichloroethylene, trimethylpentane, xylene, and/or any other solvents that may solvently weld transparent or translucent polymers. According to an embodiment, for example, wherein polymeric material comprises polyethylene terephthalate, a suitable solvent can comprise phenol, such that a solvent weld is formed between adjoined solvent welded members, wherein the solvent weld comprises conjoined polymeric material.

Furthermore, an embodiment of the current disclosure may include polymeric ¾″ thick panels to warrant extra protection from extraordinarily heavy equipment. This urn vault can also be manufactured to meet any urn size requirement. It should be understood that the current disclosure is not limited to the specific embodiments disclosed herein.

In a further embodiment, one or more of the parts comprising the polymeric urn vault (base panel, top panel, side walls, guide rails, pedestal feet, and handles) may be colored. The parts may be colored by applying a coating or by using a colored transparent or translucent polymer to create the parts.

In certain embodiments, the urn vault may not include handles.

In certain embodiments, the urn vault may not include pedestal feet.

In certain embodiments, the interior sides of the guide rails 20, 22, 24, and 26 may be solvently welded to the exterior sides of the side panels 30, 32, 34, and 36.

In certain embodiments, the bottom edges of the side panels 30, 32, 34, and 36 may be solvently welded to the top side of the base panel 18.

In certain embodiments, the interior sides of the guide rails 20, 22, 24, and 26 may be solvently welded to the exterior sides of the side panels 30, 32, 34, and 36 and the bottom edges of the side panels 30, 32, 34, and 36 may be solvently welded to the top side of the bottom panel 18.

For the purposes of this disclosure, the term “solvent adhesive” includes, but is not limited to, a solvent that breaks down the bonds of a polymer (softens the polymer) and allows two “softened” polymers to be joined and subsequently fused together.

For the purposes of this disclosure, the terms “solvent adhesive” and “solvent” are synonymous.

For the purposes of this disclosure, the terms “top panel” and “top enclosure panel” are synonymous.

For the purposes of this disclosure, the terms “top portion” and “first vault structural member” are synonymous.

Having thus described the current disclosure, what is desired to be protected by Letters Patent is presented in the subsequently appended claims.

1. An urn vault for containing a cremation urn, comprising:
at least one side panel, wherein each of the at least one side panels comprises an interior surface, an exterior surface, and a bottom edge, further wherein the at least one side panel forms an enclosure for receiving the cremation urn;
a top enclosure panel coupled to the at least one side panel;
a base panel comprising a top side and a bottom side, wherein the at least one side panel, top enclosure panel, and base panel are at least partially transparent; and
at least one channel positioned on the top side of the base panel;
wherein the bottom edge of the at least one side panel is configured for sealing mating engagement with the at least one channel.

2. The urn vault of claim 1, wherein one of the at least one side panel is coupled to itself.

3. The urn vault of claim 1, wherein more than one of the at least one side panel are coupled to each other.

4. The urn vault of claim 1, wherein the bottom edge of the at least one side panel is solvently welded to the at least one channel positioned on the top side of the base panel.

5. The urn vault of claim 1, wherein at least one of the at least one side panel, the top enclosure panel, and the base panel consist of a transparent or translucent polymer.

6. The urn vault of claim 5, wherein the transparent or translucent polymer is colored.

7. The urn vault of claim 1, wherein the at least one side panel comprises at least one handle for transporting the urn vault.

8. The urn vault of claim 1, wherein the urn vault comprises at least one pedestal foot coupled to the bottom side of the base panel.

9. The urn vault of claim 1, wherein the at least one channel is formed by a plurality of guide rails.

10. The urn vault of claim 1, wherein the at least one channel is formed by a recess in the top side of the base panel.

11. An urn vault for containing a cremation urn, comprising:
at least one side panel, wherein each of the at least one side panels comprises an interior surface, an exterior surface, and a bottom edge, further wherein the at least one side panel forms an enclosure for receiving the cremation urn;
a top enclosure panel coupled to the at least one side panel;
a base panel comprising a top side and a bottom side, wherein the at least one side panel, top enclosure panel, and base panel are at least partially transparent; and
at least one channel formed in the top side of the base panel;
wherein the bottom edge of the at least one side panel is configured for sealing mating engagement with the at least one channel.

12. The urn vault of claim 11, wherein one of the at least one side panel is coupled to itself.

13. The urn vault of claim 11, wherein more than one of the at least one side panel are coupled to each other.

14. The urn vault of claim 11, wherein the bottom edge of the at least one side panel is solvently welded to the at least one channel.

15. The urn vault of claim 11, wherein at least one of the at least one side panel, the top enclosure panel, and the base panel consist of a transparent or translucent polymer.

16. The urn vault of claim 15, wherein the transparent or translucent polymer is colored.

17. The urn vault of claim 11, wherein the at least one side panel comprises at least one handle for transporting the urn vault.

18. The urn vault of claim 11, wherein the urn vault comprises at least one pedestal foot coupled to the bottom side of the base panel.

19. The urn vault of claim 11, wherein the at least one channel is formed in the top side of the base panel through an etching process.

20. The urn vault of claim 11, wherein the at least one channel is formed in the top side of the base panel through injection molding.

21. The urn vault of claim 11, wherein the at least one channel is formed by a recess in the top side of the base panel.

22. An urn vault for containing a cremation urn with a channel sealing system base, comprising:
a plurality of side panels, wherein each of the plurality of side panels comprises an interior surface an exterior surface, and a bottom edge, further wherein the plurality of side panels form an enclosure for receiving the cremation urn;
a top enclosure panel coupled to the plurality of side panels;
a base panel comprising a top side, a bottom side, and a plurality of side edges wherein the plurality of side panels, top enclosure panel, and base panel are at least partially transparent; and
a plurality of channels formed in the top side of the base panel inset from the plurality of side edges of the base panel;
wherein the plurality of channels are configured to receive the bottom edge of the plurality of side panels to seal the urn vault.

23. The urn vault of claim 22, wherein the plurality of side panels are coupled to each other.

24. The urn vault of claim 22, wherein the plurality of channels are formed in the top side of the base panel equidistant from the outside edges of the base panel.

25. The urn vault of claim 22, wherein the bottom edges of the plurality of side panels are solvently welded to the plurality of channels formed on the top side of the base panel.

26. The urn vault of claim 22, wherein at least one of the plurality of side panels, the top enclosure panel, and the base panel consist of a transparent or translucent polymer.

27. The urn vault of claim 26, wherein the transparent or translucent polymer is colored.

28. The urn vault of claim 22, wherein at least one of the plurality of side panels comprises at least one handle for transporting the urn vault.

29. The urn vault of claim 22, wherein the urn vault comprises at least one pedestal foot coupled to the bottom side of the base panel.

30. The urn vault of claim 22, wherein the plurality of channels are formed by a plurality of recesses in the top side of the base panel.
